(19) United States
(12) Patent Application Publication
(10) Pub. No.: US 2013/0103360 A1
(43) Pub. Date: Apr. 25, 2013

(54) METHOD FOR CONSTRUCTING MODELS OF ANIMALS AND ELECTRONIC APPARATUSES APPLYING THE SAME

(71) Applicant: MING-HSIEN HSU, Taipei (TW)

(72) Inventor: MING-HSIEN HSU, Taipei (TW)

(73) Assignee: INVENTEC CORPORATION, Taipei (TW)

(21) Appl. No.: 13/325,699

(22) Filed: Dec. 14, 2011

(30) Foreign Application Priority Data
Oct. 25, 2011 (TW) 100138704

(51) Int. Cl. G06F 17/50

(52) U.S. Cl. 703/1

(57) ABSTRACT

A method for constructing models of animals and an electronic apparatus applying the same are disclosed, in which the animal model construction method comprises the step of: using an imaging device for capturing images of a specific animal at different viewpoints so as to form a plurality of animal images; inputting the plural animal images into an animal model construction system, which has an animal species database embedded therein, for allowing the system to perform a species discrimination analysis so as to find a matching animal prototype from the animal species database; adjusting the matched animal prototype according to the distinctive appearance features of the specific animal that are obtained from the plural animal images so as to construct a primary animal model; and enabling the primary animal model to move and give off sound in a manner the same as the real specific animal.

### FIELD OF THE INVENTION

The present invention relates to a method for constructing models of animals and an electronic apparatus applying the same, and more particularly, to a method capable of constructing a model of an animal that not only looks like the animal in appearance, but also is able to move and sound exact the same as the animal, while causing a virtual space mimicking a real-world living environment of the animal to be generated. The method can be applied in an electronic apparatus in which the animal model is enabled to interact with a user in the virtual space in a manner similar to a real pet living and playing with one's owner.

### BACKGROUND OF THE INVENTION

Generally, most electronic pet games that are available today are a software embedded in an electronic apparatus for enabling a user to adopt a pet that is almost real. The virtual pet, no matter it is a cat, a dog, a bird or a rabbit, can interact with the user according to the design of the software in a manner similar to a real pet living and playing with one's owner. Such electronic pet games not only can be very entertaining, but also can be educational.

However, for any one conventional electronic pet game, it is disadvantageous in that the amount of virtual pets as well as their living environments being provided in the game are limited and can not be changed or increased at will. Thus, for different users playing the same electronic pet game and keeping the same species of pet, such as a cat, it is more than common that they are keeping the same cat in the same environment. In addition to that, since no matter how long a virtual pet is being kept, its appearance will never change, resulting that not only the virtual pet is not real enough, but also the interest and fun coming from the interaction between the user and the pet is reduced. Moreover, in most conventional electronic pet games, there can only be a limited amount of pet species available and there is no way to change or increase the type of pet available. Consequently, a user who wants to adopt a species of pet and can not find the species on the one electronic pet game he/she is playing right now will have to purchase a new electronic pet game just to do so.

### SUMMARY OF THE INVENTION

In view of the disadvantages of prior art, the object of the present invention is to provide a method for constructing models of animals and an electronic apparatuses applying the same, capable of constructing a model of an animal that not only looks like the animal in appearance, but also is able to move and sound exact the same as the animal, while causing a virtual space mimicking a real-world living environment of the animal to be generated. The method can be applied in an electronic apparatus in which the animal model is enabled to interact with a user in the virtual space in a manner similar to a real pet living and playing with one's owner.

To achieve the above object, the present invention provides a method for constructing models of animals, which comprises the step of:
using an imaging device for capturing images of a specific animal at different viewpoints so as to form a plurality of animal images;
inputting the plural animal images into an animal model construction system, which has an animal species database embedded therein, for allowing the system to perform a species discrimination analysis using the plural animal images so as to find a matching animal prototype from the animal species database;
adjusting the matched animal prototype according to the distinctive appearance features of the specific animal that are obtained from the plural animal images so as to construct a primary animal model; and
enabling the primary animal model to move and give off sound in a manner the same as the specific animal.

In an embodiment, the present invention further provides an electronic apparatus, which comprises:
an imaging device, for capturing images of a specific animal at different viewpoints so as to form a plurality of animal images accordingly; and
an animal model construction system embedded with an animal species database, for accessing the plural animal images in the calculation of a species discrimination analysis for finding a matching animal prototype from the animal species database, and then adjusting the matched animal prototype according to the distinctive appearance features of the specific animal that are obtained from the plural animal images so as to construct a primary animal model while enabling the primary animal model to move and give off sound in a manner the same as the specific animal.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a flow chart depicting the steps performing in a method for constructing models of animals according to the present invention.

FIG. 2 is a block diagram showing an electronic apparatus provided in the present invention.

FIG. 3 is a schematic diagram illustrating how the step 12 in FIG. 1 is performed as well as the result thereof.

FIG. 4 is a schematic diagram illustrating how the step 13 in FIG. 1 is performed as well as the result thereof.

FIG. 5 is a schematic diagram showing the appearance of a primary animal model being constructed in the present invention.

FIG. 6 is a schematic diagram showing a primary animal model that is living in a corresponding virtual space mimicking its natural living environment according to an embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

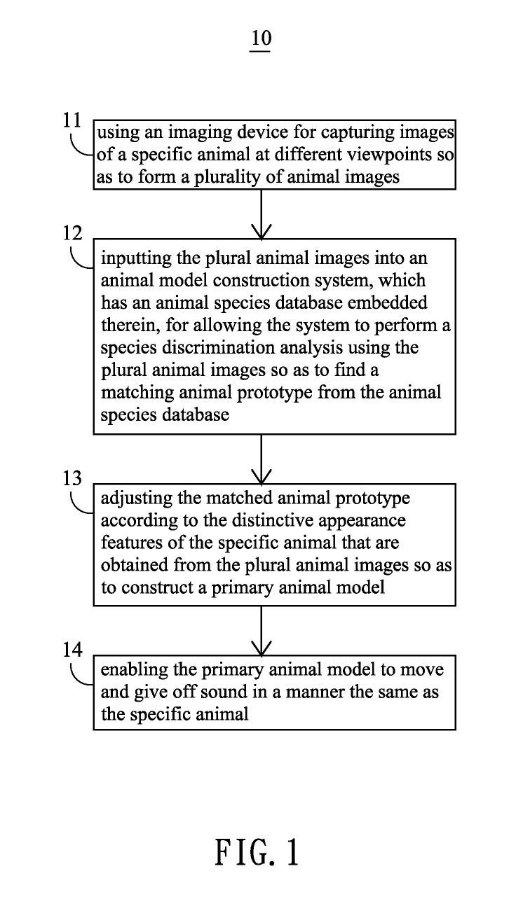

Please refer to FIG. 1, which is a flow chart depicting the steps performing in a method for constructing models of animals according to the present invention. In FIG. 1, the method for constructing models of animals 10 comprises the following steps:

step 11: using an imaging device for capturing images of a specific animal at different viewpoints so as to form a plurality of animal images;
step 12: inputting the plural animal images into an animal model construction system, which has an animal species database embedded therein, for allowing the system to perform a species discrimination analysis using the plural animal images so as to find a matching animal prototype from the animal species database;
step 13: adjusting the matched animal prototype according to the distinctive appearance features of the specific animal that are obtained from the plural animal images so as to construct a primary animal model; and
step 14: enabling the primary animal model to move and give off sound in a manner the same as the specific animal.

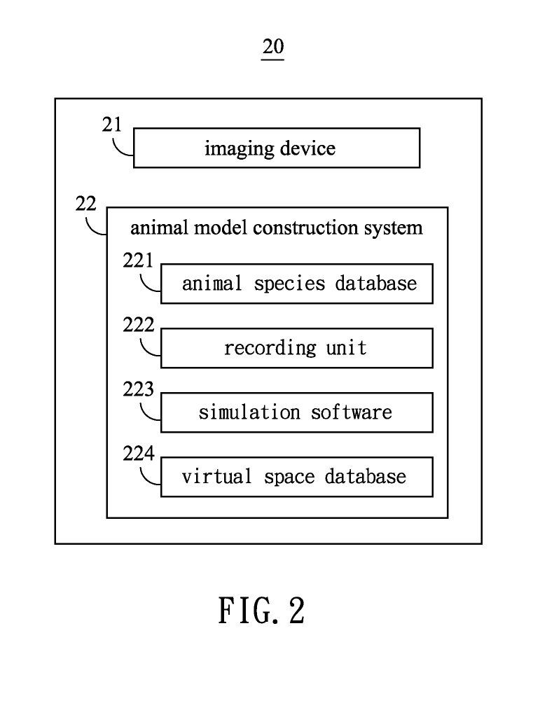

Moreover, it is noted that the imaging device used in the aforesaid method can be a camera or an imaging device embedded inside an electronic apparatus that is adapted for applying the method of the present invention. Please refer to FIG. 2, which is a block diagram showing an electronic apparatus provided in the present invention. As shown in FIG. 2, the electronic apparatus 20 comprises: an imaging device 21 and an animal model construction system 22, in which the animal model construction system further comprises: an animal species database 221, a recording unit 222, a simulation software 223 and a virtual space database 224.

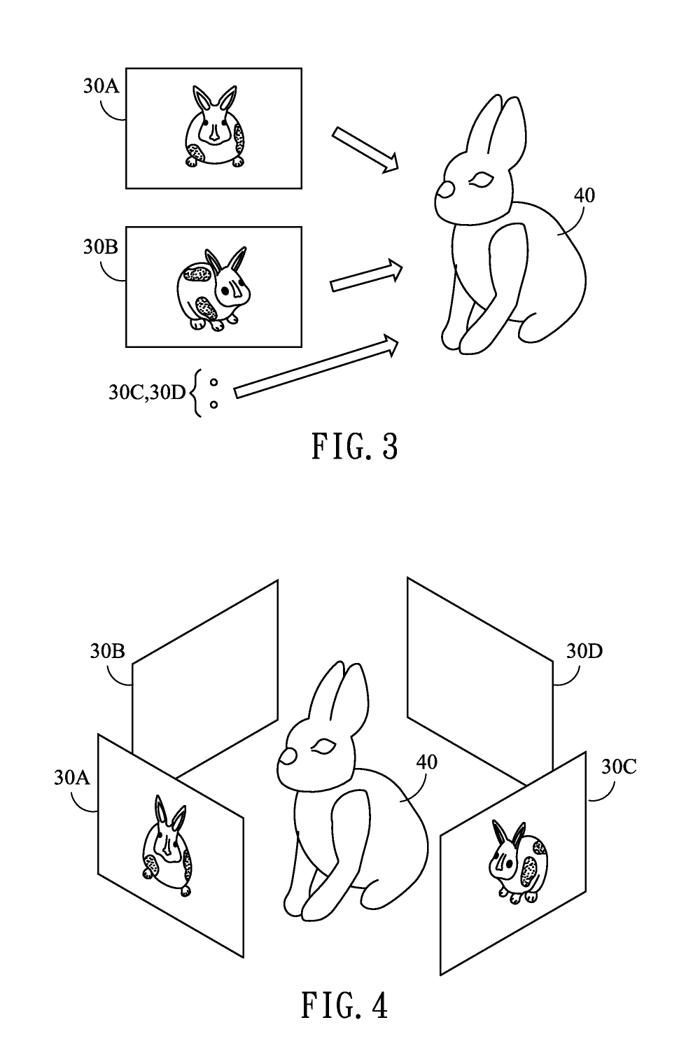

Operationally, in a condition when a user is intended to have an electronic pet resembling a pet rabbit of the user, the user will first uses the imaging device to take a plurality of pictures of the pet rabbit at different viewpoints so as to obtain a plurality of animal images 30A-30D, as the front view, the rear view, the left-side view, the right-side view, the top view, the bottom view and a three-dimensional view of the pet rabbit that are shown in FIG. 3, and then enabling the plural animal images 30A-30D to be stored in the electronic apparatus 20, as proceeding in the step 11.

Thereafter, the plural animal images 30A-30D is provided to the animal model construction system 22 embedded in the electronic apparatus 20, as proceeding in the step 12, while allowing the animal model construction system 22 to perform the species discrimination analysis using the plural animal images 30A-30D. In an embodiment of the present invention, the performing of the species discrimination analysis includes the steps of: enabling the animal model construction system 22 to scan and analyze the build feature and face feature in the plural animal images 30A-30D so as to obtain a body outline and a face outline matching to the build and face features; and enabling the animal model construction system 22 to identify the species of the specific animal according to the body outline and the face outline. In this embodiment, as there are a variety of prototype animals stored in the animal species database 221, such as cat, dog, rabbit, bird, etc., the animal model construction system 22 is able to find a matched prototype animal from the animal species database 221, which is a prototype rabbit 40, as the one shown in FIG. 3. Nevertheless, the prototype rabbit 40 is freshly retrieved from the animal species database 221 is only a statue that do not possess the same features as the pet rabbit and is not liveliness also.

Therefore, the step 13 is proceeded for adjusting the matched animal prototype according to the distinctive appearance features of the pet rabbit so as to construct a primary animal model. In an embodiment, the step 13 is performed by patching the three-dimensional prototype rabbit 40 with a plurality of features obtained from the real pet rabbit for constructing a primary animal model that resembles to the pet rabbit.

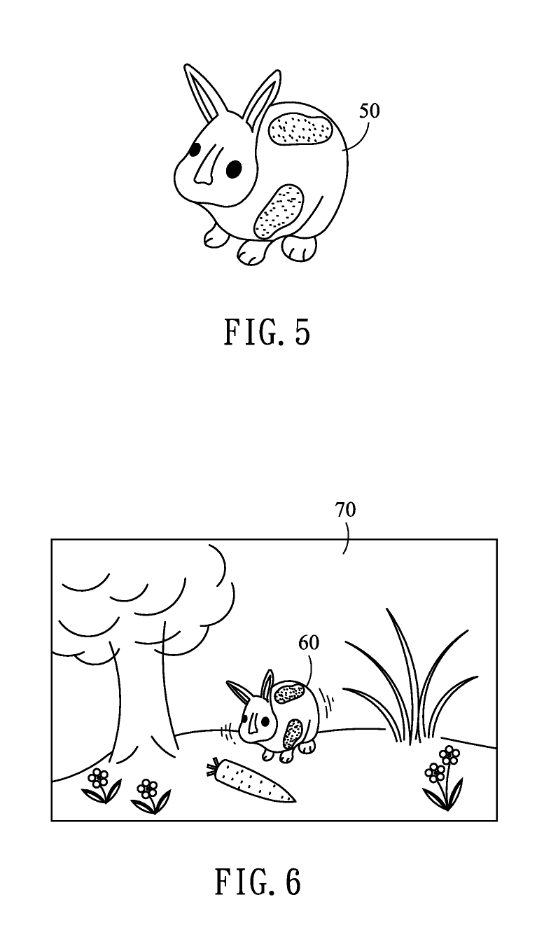

It is noted that there can be a variety of appearance features that can be obtained from the animal images 30A-30D in the step 11. In an embodiment of the present invention, the distinctive appearance features includes: at least one build feature, being a feature relating to how large, how small, how long, how short, how tall and how short the specific animal is; at least one face feature, being a feature selected from the group consisting of: the face shape, the outlines and relative positions of face organs; and at least one body feature, being a feature selected from the group consisting of: color, spot, and fur length. Please refer to FIG. 4, which is a schematic diagram illustrating how the step 13 in FIG. 1 is performed as well as the result thereof. As shown in FIG. 4, the prototype rabbit 40 is patched by the animal images 30A-30D at their respective corresponding positions, that is, the front view is patched to the front of the prototype rabbit 40, the rear view is patched to the rear of the prototype rabbit 40, the left-side view is patched to the left side of the prototype rabbit 40, the right-side view is patched to the right side of the prototype rabbit 40, and so on. Moreover, the animal model construction system 22 further uses its simulation software 223 to adjust the size, the face and body of the prototype rabbit 40, and thus a primary rabbit model 50 that look exactly the same as the pet rabbit can be constructed, as the one shown in FIG. 5. However, the primary rabbit model 50 is still a model that is not liveliness.

Thus, the step 14 is required for enabling the primary animal model 50 to move and give off sound in a manner the same as the specific animal. For instance, if the primary animal model 50 is a rabbit, it should be able to run and jump; and if the primary animal model 50 is a bird, it should be able to fly and sing. Therefore, in step 14, the simulation software is used for attached the habitual behavior in movement and sound of the specific animal, i.e. the pet rabbit, to the primary rabbit model 50. Although the pet rabbit is in general not very vocal, therefore, it is not required to have the recoding unit 222 to perform any recording session. However, if the pet is a cat, a dog or a bird, it is required to have the recoding unit 222 to record sounds issues from the pet animal, while enabling the recorded sound to be analyzed in a frequency analysis of the simulation software 223 in the animal model construction system 22 so as to enable the primary animal model 50 to give off sound in a manner the same as the real pet. In addition, the animal model construction system is enabled to identify the species of the specific animal according to the result of the frequency analysis.

Consequently, after completing the step 11-14, a animal model 60 that resembles a real animal in looks, movements and sounds can be obtained, as the one shown in FIG. 6. Moreover, the animal model construction system 22 embedded in the electronic apparatus 20 further comprises: a virtual space database 224, which have at least one simulated virtual space registered therein so as to be used for mimicking a real-world living environment for the primary animal model. On the other hand, by the use of the imaging device 21 in the electronic apparatus 20, any use is able to create a virtual living environment for one's electronic pet at will, whereas the creating process is performed as following: using the imaging device 20 to captured a plurality of environment images, whereas the plural environment images are images of a real-world living environment for the specific animal that are captured in different viewpoints; inputting a plurality of environment images into the animal model construction system 22 for integrating the plural environment images with the simulated virtual space obtained from the virtual space database 224 so as to generate a virtual space model 70, as shown in FIG. 6; and finally, combing the virtual space model 70 with the primary animal model 60 so as to complete the mimicking of the real-world living environment.

To sum up, the present invention provides a method for constructing models of animals, that is capable of constructing a model of an animal that not only looks like the animal in appearance, but also is able to move and sound exact the same as the animal, while causing a virtual space mimicking a real-world living environment of the animal to be generated. The method can be applied in interactive game embedded in an electronic apparatus, in which the animal model is enabled to interact with a user in the virtual space in a manner similar to a real pet living and playing with one's owner.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A method for constructing models of animals, comprising the steps of:
using an imaging device for capturing images of a specific animal at different viewpoints so as to form a plurality of animal images;
inputting the plural animal images into an animal model construction system, which has an animal species database embedded therein, for allowing the system to perform a species discrimination analysis using the plural animal images so as to find a matching animal prototype from the animal species database;
adjusting the matched animal prototype according to the distinctive appearance features of the specific animal that are obtained from the plural animal images so as to construct a primary animal model; and
enabling the primary animal model to move and give off sound in a manner the same as the specific animal.

2. The method of claim 1, wherein the distinctive appearance features of the specific animal includes:
at least one build feature, being a feature relating to how large, how small, how long, how short, how tall and how short the specific animal is, capable of being as used as base in the animal model construction system for adjusting the build of the matched animal prototype accordingly;
at least one face feature, being a feature selected from the group consisting of: the face shape, the outlines and relative positions of face organs, capable of being as used as base in the animal model construction system for adjusting the face of the matched animal prototype accordingly; and
at least one body feature, being a feature selected from the group consisting of: color, spot, and fur length, capable of being as used as base in the animal model construction system for adjusting the body of the matched animal prototype accordingly;

3. The method of claim 1, wherein the animal model construction system further comprises:
a virtual space database, having at least one simulated virtual space registered therein that is used for mimicking a real-world living environment for the primary animal model.

4. The method of claim 3, wherein the mimicking of the real-world living environment for the primary animal model using the virtual space database is performed as following:
inputting a plurality of environment images into the animal model construction system, whereas the plural environment images are images of a real-world living environment for the specific animal that are captured in different viewpoints;
integrating the plural environment images with the at least one simulated virtual space in the virtual space database so as to generate a virtual space model; and
combing the virtual space model with the primary animal model so as to complete the mimicking of the real-world living environment for the primary animal model.

5. The method of claim 1, wherein the animal model construction system further comprises:
a recording unit, for recoding a sound issued from the specific animal to be used in a frequency analysis for generating a sound for the primary animal model.

6. The method of claim 2, wherein the performing of the species discrimination analysis includes the steps of:
scanning and analyzing the build feature and face feature in the plural animal images so as to obtain a body outline and a face outline matching to the build and face features; and
enabling the animal model construction system to identify the species of the specific animal according to the body outline and the face outline.

7. The method of claim 5, wherein the animal model construction system is enabled to identify the species of the specific animal according to the result of the frequency analysis.

8. An electronic apparatus, comprising:
an imaging device, for capturing images of a specific animal at different viewpoints so as to form a plurality of animal images accordingly; and
an animal model construction system embedded with an animal species database, for accessing the plural animal images in the calculation of a species discrimination analysis for finding a matching animal prototype from the animal species database, and then adjusting the matched animal prototype according to the distinctive appearance features of the specific animal that are obtained from the plural animal images so as to construct a primary animal model while enabling the primary animal model to move and give off sound in a manner the same as the specific animal.

9. The electronic apparatus of claim 8, wherein the animal model construction system further comprises:
a recording unit, for recoding a sound issued from the specific animal to be used in a frequency analysis for generating a sound for the primary animal model.

10. The electronic apparatus of claim 8, wherein the animal model construction system further comprises
a simulation software, for adjusting the matched animal prototype according to the distinctive appearance features of the specific animal so as to enable the primary animal model to move and give off sound in a manner the same as the specific animal.
